(19) United States
(12) Patent Application Publication
(10) Pub. No.: US 2021/0103752 A1
(43) Pub. Date: Apr. 8, 2021

(54) RECOGNITION DEVICE, RECOGNITION METHOD, AND STORAGE MEDIUM

(71) Applicant: HONDA MOTOR CO., LTD., Tokyo (JP)

(72) Inventors: Dan Umeda, Wako-shi (JP); Teruki Takahashi, Wako-shi (JP)

(21) Appl. No.: 17/033,979

(22) Filed: Sep. 28, 2020

(30) Foreign Application Priority Data
Oct. 3, 2019 (JP) 2019-182949

(51) Int. Cl. G06K 9/32; G06T 7/11; G06T 7/181; G06T 7/246

(52) U.S. Cl. CPC G06K 9/3241; G06T 7/11; G06T 7/181; G06T 2207/20081; G06T 2207/30252; G06T 2207/10021; G06T 7/246

(57) ABSTRACT

A recognition device includes: a first area setting unit configured to recognize a target object shown in a two-dimensional image captured by an imaging device imaging a vicinity of a vehicle and set a first area including the recognized target object inside the two-dimensional image; a second area setting unit configured to set a second area coinciding with a reference surface among surfaces constituting the target object; and a third area setting unit configured to set a third area representing an area of the target object in a predetermined shape on the basis of the first area and the second area.

### CROSS-REFERENCE TO RELATED APPLICATION

Priority is claimed on Japanese Patent Application No. 2019-182949, filed Oct. 3, 2019, the content of which is incorporated herein by reference.

### BACKGROUND OF THE INVENTION

### Field of the Invention

The present invention relates to a recognition device, a recognition method, and a storage medium.

### Description of Related Art

Conventionally, technologies relating to display control devices that extract an object image matching extraction conditions from a captured image of a side in front of a vehicle, calculate coordinates of a three-dimensional space of the extracted object image, and display information relating to the extracted object have been disclosed (for example, see PCT Publication No. 2017/002209).

### SUMMARY OF THE INVENTION

Generally, in order to perform a process for an object present in a three-dimensional space, for example, an image needs to be three-dimensionally captured using a stereo camera or the like, and the load of a process for acquiring a position at which an object is present on the basis of a captured three-dimensional image is high.

An aspect according to the present invention is in view of recognition of the problems described above, and an object thereof is to provide a recognition device, a recognition method, and a storage medium capable of recognizing an area in which a target object is present inside a three-dimensional space with a low load.

In order to achieve the relating object by solving the problems described above, the present invention employs the following aspects.

(1): According to one aspect of the present invention, there is provided a recognition device including: a first area setting unit configured to recognize a target object shown in a two-dimensional image captured by an imaging device imaging a vicinity of a vehicle and set a first area including the recognized target object inside the two-dimensional image; a second area setting unit configured to set a second area coinciding with a reference surface among surfaces constituting the target object; and a third area setting unit configured to set a third area representing an area of the target object in a predetermined shape on the basis of the first area and the second area.

(2): In the aspect (1) described above, the target object may be another vehicle present in the vicinity of the vehicle, and the reference surface may be a front face or a rear face of the other vehicle.

(3): In the aspect (1) or (2) described above, the first area setting unit may acquire and set the first area by inputting the two-dimensional image to a first learned model that has learned to output the first area when the two-dimensional image is input, and the second area setting unit may acquire and set the second area by inputting an image of the first area to a second learned model that has learned to output the second area when the image of the first area is input.

(4): In any one of the aspects (1) to (3) described above, the third area setting unit may set a fourth area, which has the same size as that of the second area or a size reduced with perspective taken into account, at a position diagonally opposite to the second area inside the first area and set the third area representing a stereoscopic shape by joining points of corresponding corners of the second area and the fourth area using straight lines.

(5): The aspect (4) described above may further include a first estimation unit configured to estimate a moving direction of another vehicle on the basis of the straight lines joining the points of the corresponding corners of the second area and the fourth area in the third area, wherein the target object is the other vehicle present in the vicinity of the vehicle.

(6): The aspect (4) described above may further include a second estimation unit configured to estimate a length of another vehicle in a longitudinal direction on the basis of the straight lines joining the points of the corresponding corners of the second area and the fourth area in the third area, wherein the target object is the other vehicle present in the vicinity of the vehicle.

(7): According to one aspect of the present invention, there is provided a recognition method using a computer, the recognition method including: recognizing a target object shown in a two-dimensional image captured by an imaging device imaging a vicinity of a vehicle and setting a first area including the recognized target object inside the two-dimensional image; setting a second area coinciding with a reference surface among surfaces constituting the target object; and setting a third area representing an area of the target object in a predetermined shape on the basis of the first area and the second area.

(8): According to one aspect of the present invention, there is provided a computer-readable non-transitory storage medium storing a program causing a computer to execute: recognizing a target object shown in a two-dimensional image captured by an imaging device imaging a vicinity of a vehicle and setting a first area including the recognized target object inside the two-dimensional image; setting a second area coinciding with a reference surface among surfaces constituting the target object; and setting a third area representing an area of the target object in a predetermined shape on the basis of the first area and the second area.

According to the aspects (1) to (8) described above, an area in which a target object is present inside a three-dimensional space can be recognized with a low load.

### BRIEF DESCRIPTION OF THE DRAWINGS

FIG. 1 is a schematic configuration diagram of a recognition system including a recognition device according to a first embodiment;

FIG. 2 is a diagram schematically illustrating an example of a method of generating an entire area learned model;

FIG. 3 is a diagram schematically illustrating an example of a method of generating a reference area learned model;

FIG. 4 is a flowchart illustrating an example of the flow of a process executed by a recognition device;

FIG. 5 is a diagram schematically illustrating each process performed by a recognition device;

FIG. 6 is a diagram illustrating an example of an image displaying a target object area of another vehicle set by a recognition device in an overlapping manner;

FIG. 7 is a diagram schematically illustrating an example of estimated states of other vehicles on the basis of target object areas of the other vehicles set by a recognition device.

FIG. 8 is a configuration diagram of a vehicle system in which a function of a recognition device according to a second embodiment is mounted;

FIG. 9 is a functional configuration diagram of a first control unit and a second control unit; and

FIG. 10 is a diagram illustrating an example of the hardware configuration of the recognition device according to the first embodiment.

### DETAILED DESCRIPTION OF THE INVENTION

Hereinafter, a recognition device, a recognition method, and a storage medium according to embodiments of the present invention will be described with reference to the drawings. In the following description, an example of a case in which a recognition system including a recognition device according to the present invention is mounted in a vehicle will be described. Hereinafter, a case in which left-side traffic regulations are applied will be described. The left side and the right side may be interchanged in a road in which a rule of right-side traffic is applied.

### First Embodiment

### [Entire Configuration of Recognition System 1]

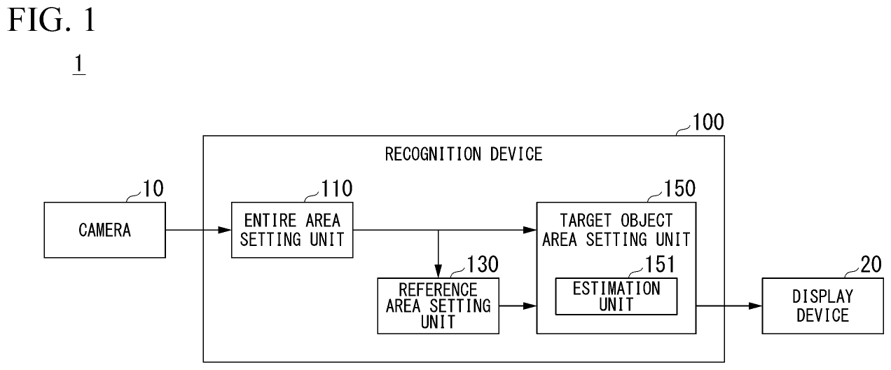

FIG. 1 is a schematic configuration diagram of a recognition system 1 including a recognition device 100 according to a first embodiment. A vehicle in which the recognition system 1 is mounted, for example, is a four-wheel vehicle, and a driving source thereof is an internal combustion engine such as a diesel engine or a gasoline engine, an electric motor, or a combination thereof. The electric motor is operated using electric power generated by a power generator connected to an internal combustion engine or discharge electric power of a secondary battery or a fuel cell.

The recognition system 1, for example, includes a camera 10 (an imaging device), a recognition device 100, and a display device 20.

The camera 10, for example, is a digital camera using a solid-state imaging device such as a charge coupled device (CCD) or a complementary metal oxide semiconductor (CMOS). The camera 10 is installed at an arbitrary place in a vehicle (hereinafter, a subject vehicle M) in which the recognition system 1 mounted. In a case in which a side in front is to be imaged, the camera 10 is attached to an upper part of a front windshield, a rear face of a room mirror, or the like. The camera 10, for example, periodically images the vicinity of the subject vehicle M repeatedly. The camera 10 outputs an image of two dimensions (hereinafter, referred to as a two-dimensional image) acquired by imaging the vicinity of the subject vehicle M to the recognition device 100.

The recognition device 100 recognizes another vehicle present in the vicinity of the subject vehicle M on the basis of a two-dimensional image output by the camera 10 as a target object and represents an area of the recognized other vehicle in a predetermined shape. For example, the recognition device 100 represents the other vehicle such that the other vehicle is recognized inside a three-dimensional space by enclosing the area of the other vehicle using an object simulating a stereoscopic shape. In the following description, an area of another vehicle recognized by the recognition device 100 will be referred to as a “target object area” (a third area). The recognition device 100 outputs an image acquired by superimposing a target object area of the recognized other vehicle in a two-dimensional image output by the camera 10 to the display device 20, thereby representing the recognized other vehicle for a driver of the subject vehicle M.

The recognition device 100, for example, includes an entire area setting unit 110 (a first area setting unit), a reference area setting unit 130 (a second area setting unit), and a target object area setting unit 150 (a third area setting unit). Such constituent elements, for example, are realized by a hardware processor such as a central processing unit (CPU) executing a program (software). Some or all of such constituent elements may be realized by hardware (a circuit unit; including circuitry) such as a large scale integration (LSI), an application specific integrated circuit (ASIC), a field-programmable gate array (FPGA), or a graphics processing unit (GPU) or may be realized by software and hardware in cooperation. Some or all of such constituent elements may be realized by a dedicated LSI. The program (software) may be stored in a storage device (a storage device including a non-transitory storage medium) such as a hard disk drive (HDD) or a flash memory in advance or may be stored in a storage medium (a non-transitory storage medium) such as a DVD or a CD-ROM and be installed in a storage device by mounting the storage medium in a drive device. The program (software) may be downloaded from another computer device through a network in advance and installed in a storage device.

The entire area setting unit 110 recognizes a target object shown in a two-dimensional image output by the camera 10 and sets an area including a recognized other vehicle inside the two-dimensional image. Target objects recognized by the entire area setting unit 110 are, for example, pedestrians, bicycles, still objects, and the like in addition to other vehicles present in the vicinity of the subject vehicle M. The other vehicles include other vehicles traveling in a traveling lane that is the same as a traveling lane in which the subject vehicle M is traveling or other vehicles traveling in a traveling lane adjacent to the traveling lane described above, other vehicle traveling in an oncoming lane (so-called opposite vehicles), parked vehicles, and the like. The still objects include traffic signals, signs, and the like. The entire area setting unit 110 sets an area of another vehicle among recognized target objects. The entire area setting unit 110 sets an area having a rectangular shape that encloses the entire area of the recognized other vehicle. The area having the rectangular shape set by the entire area setting unit 110 may partially include an area other than the other vehicle. The entire area setting unit 110 sets an area of another vehicle using a learned model that has learned in advance (hereinafter, referred to as an entire area learned model). The entire area learned model used by the entire area setting unit 110, for example, is a learned model that has learned in advance using an existing machine learning algorithm such that it outputs an area including another vehicle when a two-dimensional image is input. The entire area setting unit 110 acquires an area of another vehicle by inputting a two-dimensional image output by the camera 10 to the entire area learned model and sets an area having a rectangular shape that encloses the entire area of the other vehicle. In the following description, the area of another vehicle set by the entire area setting unit 110 will be referred to as an “entire area” (a first area). The entire area learned model used by the entire area setting unit 110 for setting an entire area, for example, may be regarded as a model that sets a bounding box that encloses the entire area of another vehicle inside a two-dimensional image in accordance with an existing image processing technology.

The entire area setting unit 110 outputs a two-dimensional image output by the camera 10 and information relating to a set entire area to the reference area setting unit 130 and the target object area setting unit 150. For example, the entire area setting unit 110 outputs a two-dimensional image output by the camera 10 and information of coordinates inside the two-dimensional image representing the range of the set entire area to the target object area setting unit 150. The entire area setting unit 110 may output an image (hereinafter, referred to as an entire area image) acquired by cutting out the range of the set entire area from the two-dimensional image to the reference area setting unit 130.

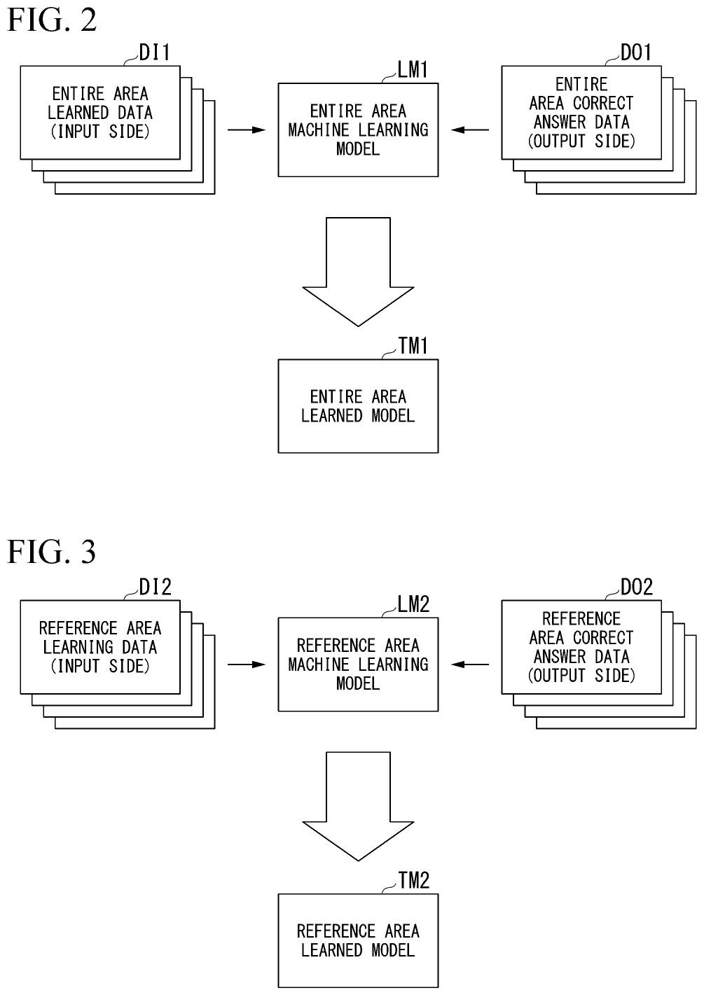

Here, the entire area learned model used by the entire area setting unit 110 for setting an entire area will be described. FIG. 2 is a diagram schematically illustrating an example of a method of generating an entire area learned model TM1 (a first learned model). The entire area learned model TM1, for example, is a model that has learned such that it outputs one or more entire areas when a two-dimensional image is input by using a technology such as a convolutional neural network (CNN) or a deep neural network (DNN). The CNN is a neural network in which several layers such as a convolution layer and a pooling layer are connected. The DNN is a neural network in which layers of arbitrary forms are connected in multiple layers. The entire area learned model TM1, for example, is generated by performing machine learning using an entire area machine learning model LM1 of an arithmetic operation device not illustrated in the drawing or the like. When the entire area learned model TM1 is generated using machine learning, the arithmetic operation device not illustrated in the drawing inputs entire area learning data DI1 to an input side of the entire area machine learning model LM1 as input data and inputs entire area correct answer data DO1 to an output side of the entire area machine learning model LM1 as teacher data. The entire area machine learning model LM1, for example, is a model that has the form of the CNN, the DNN, or the like and to which parameters are substantially set. The entire area learning data DI1, for example, is image data of a plurality of two-dimensional images assumed to be imaged by the camera 10. The entire area correct answer data DO1 is data that represents a position of an entire area to be set in the entire area learning data DIE The arithmetic operation device not illustrated in the drawing adjusts parameters of the entire area machine learning model LM1 such that an output of the entire area machine learning model LM1 at the time of inputting the entire area learning data DI1 to the entire area machine learning model LM1 comes close to the entire area represented by the entire area correct answer data DO1. As a method for adjusting the parameters, for example, a technique such as a back propagation method (an inverse propagation method) may be used. The entire area machine learning model LM1 of which parameters have been adjusted by the arithmetic operation device not illustrated in the drawing is the entire area learned model TM1.

Referring back to FIG. 1, the reference area setting unit 130 recognizes a predetermined surface of another vehicle included in an entire area image output by the entire area setting unit 110 as a reference surface and sets an area of the recognized reference surface. The reference surface recognized by the reference area setting unit 130 is a face on a side close from the subject vehicle M (a side close to the subject vehicle M) in a case in which the shape of another vehicle is assumed to be a parallelepiped shape and, for example, is a front face (a face on a side in front) or a rear face (a face on a side in rear) of another vehicle. The front face of another vehicle, for example, can be recognized also at night by recognizing a headlight part of the another vehicle. A rear face of another vehicle, for example, can be recognized also at night by recognizing a tail light part of the another vehicle. The reference area setting unit 130 recognizes a reference surface (a face coinciding with a reference surface) among surfaces constituting another vehicle inside the entire area and sets an area having a rectangular shape that represents the recognized reference surface. The area having the rectangular shape that represents the reference surface may partially enter the inside of another vehicle or may partially include an area other than another vehicle. The reference area setting unit 130 sets an area representing the reference surface using a learned model that has learned in advance (hereinafter, referred to as a reference area learned model). The reference area learned model used by the reference area setting unit 130, for example, is a learned model that has learned in advance using an existing machine learning algorithm such that it outputs an area of the reference surface when an entire area image is input. The reference area setting unit 130 acquires an area of a reference surface of another vehicle by inputting an entire area image output by the entire area setting unit 110 to the reference area learned model and sets an area having a rectangular shape representing the reference surface of the another vehicle. In the following description, an area of a reference surface of another vehicle set by the reference area setting unit 130 will be referred to as a “reference area” (a second area). The reference area learned model that is used by the reference area setting unit 130 for setting a reference area, for example, may be also regarded as a model that sets a bonding box enclosing the reference surface among surfaces constituting another vehicle of the entire area image in accordance with an existing image processing technology.

The reference area setting unit 130 outputs information relating to the set reference area to the target object area setting unit 150. For example, the reference area setting unit 130 outputs information of coordinates representing a range of a set reference area inside an entire area image to the target object area setting unit 150. Information indicating whether the reference area is an area of the front face or an area of the rear face of another vehicle is also included in the information relating to the reference area output by the reference area setting unit 130.

Here, the reference area learned model used by the reference area setting unit 130 for setting a reference area will be described. FIG. 3 is a diagram schematically illustrating an example of a method of generating a reference area learned model TM2 (a second learned model). The reference area learned model TM2, for example, is a model that has learned using a technology of the CNN, the DNN, or the like such that it outputs one or more reference areas when an entire area image is input. The reference area learned model TM2 is, for example, generated by machine learning using a reference area machine learning model LM2 using an arithmetic operation device not illustrated in the drawing or the like. When a reference area learned model TM2 is generated using machine learning, the arithmetic operation device not illustrated in the drawing inputs reference area learning data DI2 to the input side of the reference area machine learning model LM2 as input data and inputs reference area correct answer data DO2 to the output side of the reference area machine learning model LM2 as teacher data. The reference area machine learning model LM2, for example, is a model which has the form of the CNN, the DNN, or the like and to which parameters have been substantially set. The reference area learning data D12, for example, is image data of a plurality of entire area images assumed to be output from the entire area setting unit 110. The reference area correct answer data DO2 is data that represents a position of a reference area to be set in the reference area learning data D12. The arithmetic operation device not illustrated in the drawing adjusts parameters of the reference area machine learning model LM2 such that an output of the reference area machine learning model LM2 at the time of inputting the reference area learning data D12 to the reference area machine learning model LM2 comes close to a reference area represented by the reference area correct answer data D02. As a method for adjusting the parameters, for example, similar to the method for adjusting the parameters of the entire area machine learning model LM1, there is a technique such as a back propagation method (an inverse propagation method). The reference area machine learning model LM2 of which parameters have been adjusted by the arithmetic operation device not illustrated in the drawing is the reference area learned model TM2.

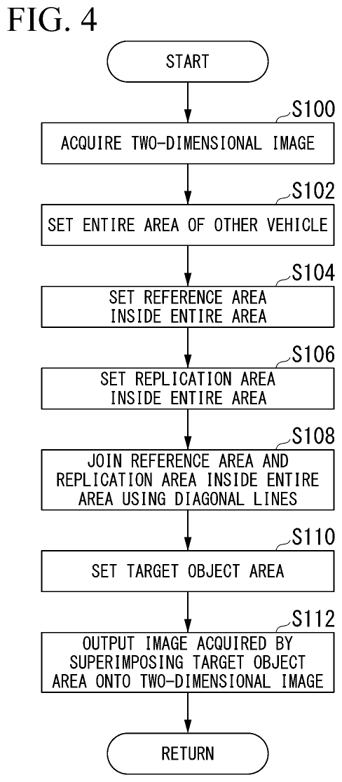

The target object area setting unit 150 encloses an area of another vehicle shown in the two-dimensional image using an object simulating a stereoscopic shape on the basis of information relating to an entire area output by the entire area setting unit 110 and information relating to a reference area output by the reference area setting unit 130, thereby setting a target object area representing that another vehicle is recognized inside a three-dimensional space. At this time, the target object area setting unit 150 sets an area (hereinafter, referred to as a replication area) having the same size as that of the reference area inside the entire area as a position diagonally opposite inside the entire area and joins points of corresponding corners of the reference area and the replication area using straight lines (hereinafter, referred to as diagonal lines), thereby setting a target object area in which the area of another vehicle is represented using a stereoscopic shape. In other words, the target object area setting unit 150 sets a target object area acquired by excluding the reference area, the replication area, and an area not enclosed by diagonal lines from the entire area. Detailed description will be presented with reference to FIG. 4. When a replication area is set inside the entire area, the target object area setting unit 150 may set a replication area having a size acquired by reducing the size of the reference area with perspective taken into account. The target object area set by the target object area setting unit 150 may be regarded as a three-dimensional box acquired by joining a bounding box (a reference area) set by the reference area setting unit 130 and a bounding box (a replication area (fourth area)) set by the target object area setting unit 150 using diagonal lines.

The target object area setting unit 150 outputs an image acquired by superimposing the set target object area onto the two-dimensional image output by the entire area setting unit 110 to the display device 20.

The target object area setting unit 150, for example, includes an estimation unit 151. The estimation unit 151 estimates a state of another vehicle on the basis of the set target object area. The state of another vehicle includes a distance between the subject vehicle M and the other vehicle, a moving direction of the other vehicle in a case in which the traveling direction of the subject vehicle M is set as a reference, a length of the other vehicle in a longitudinal direction (a depth direction away from the subject vehicle M) in a case in which the traveling direction of the subject vehicle M is set as a reference. A distance between the subject vehicle M and the other vehicle, for example, may be estimated on the basis of the size of the reference area. The moving direction of the other vehicle and the length of the other vehicle in the longitudinal direction can be estimated on the basis of diagonal lines joining points of corresponding corners of the reference area and the replication area at the time of setting a target object area. The estimation unit 151 may correct the moving direction of the other vehicle and the length of the other vehicle in the longitudinal direction that have been estimated with perspective taken into account.

For example, in a case in which a virtual line representing the traveling direction of the subject vehicle M and an extending line of a diagonal line joining the reference area and the replication area are approximately parallel to each other, the estimation unit 151 estimates that the moving direction of the other vehicle is the same as or opposite to the traveling direction of the subject vehicle M. Here, being approximately parallel represents that an angle between the virtual line representing the traveling direction of the subject vehicle M and an extending line of the diagonal line joining the reference area and the replication area enters a range of several degrees. For example, in a case in which the virtual line representing the traveling direction of the subject vehicle M and the extending line of the diagonal line joining the reference area and the replication area intersect with each other, the estimation unit 151 estimates that the moving direction of another vehicle is a direction intersecting with the traveling direction of the subject vehicle M. Here, intersecting represents that the virtual line representing the traveling direction of the subject vehicle M and the extending line of the diagonal line joining the reference area and the replication area intersect with each other at an arbitrary position. For example, the estimation unit 151 may estimate another vehicle in more detail on the basis of information indicating whether the reference area is an area of the front face or an area of the rear face of the another vehicle. For example, when it is estimated that the moving direction of another vehicle is the same as or opposite to the traveling direction of the subject vehicle M, the estimation unit 151 can estimate that the other vehicle is, for example, a vehicle that passes by the subject vehicle M such as an oncoming vehicle in a case in which the reference area is the front face of the other vehicle and can estimate that the other vehicle is, for example, a vehicle traveling a side in front of the subject vehicle M such as a preceding vehicle in a case in which the reference area is the rear face of the other vehicle. For example, when it is estimated that the moving direction of another vehicle is a direction intersecting with the traveling direction of the subject vehicle M, the estimation unit 151 can estimate that the other vehicle, for example, is a vehicle having a likelihood of traversing a side in front of the subject vehicle M such as a vehicle passing or making a turn at an intersection disposed in front of the subject vehicle M in a case in which the reference area is the front face of the other vehicle and can estimate that the other vehicle is, for example, a vehicle having a likelihood of entering the traveling lane in which the subject vehicle M is traveling in a case in which the reference area is the rear face of the other vehicle. The estimation unit 151 estimating the moving direction of the other vehicle in this way is called a “first estimation unit”.

For example, the estimation unit 151 estimates the length of the diagonal line joining the reference area and the replication area as a length of the other vehicle in the longitudinal direction (for example, a vehicle length). In this case, for example, in a case in which another vehicle is a parked vehicle, the estimation unit 151 can estimate a time at which the subject vehicle M arrives at the position of the parked vehicle, a time required for the subject vehicle M to pass the parked vehicle, and the like in more detail on the basis of an estimated distance between the subject vehicle M and the other vehicle and the length of the other vehicle in the longitudinal direction. The estimation unit 151 estimating the length of the other vehicle in the longitudinal direction in this way is called a “second estimation unit”.

The target object area setting unit 150 may output an image acquired by superimposing information representing the state of the other vehicle estimated by the estimation unit 151 on a two-dimensional image output by the entire area setting unit 110 to the display device 20. The target object area setting unit 150 may output information representing the state of the other vehicle estimated by the estimation unit 151 to another constituent element not illustrated in the drawing. As the other constituent element, for example, a constituent element controlling automated driving in the subject vehicle M or a constituent element supporting driving in the subject vehicle M may be considered. In this case, such a constituent element can control automated driving or driving supporting on the basis of information representing the state of the other vehicle output by the target object area setting unit 150.

The display device 20 displays an image output by the recognition device 100. The display device 20, for example, is a liquid crystal display (LCD), an organic electroluminescence (EL) display device, or the like. The display device 20, for example, may be a display device of a navigation device included in the subject vehicle M. The display device 20, for example, may be a display device (a so-called head-up display device) displaying an image or information inside the plane of a front glass window of the subject vehicle M. A driver can visually recognize that the subject vehicle M has recognized the presence of the other vehicle by viewing an image displayed by the display device 20.

### [Processing Example of Recognition Device 100]

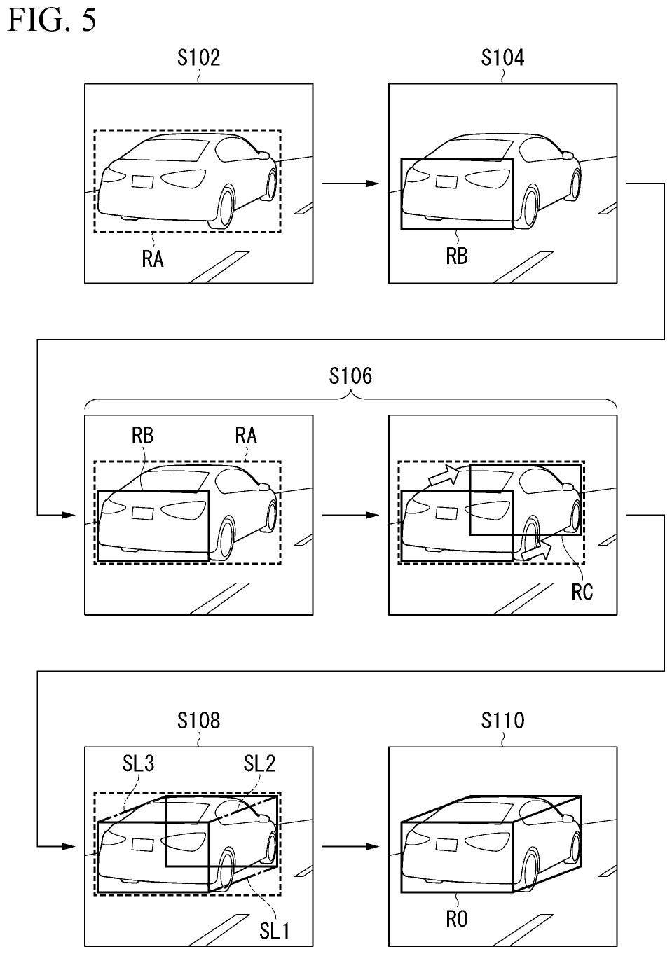

FIG. 4 is a flowchart illustrating an example of the flow of a process executed by the recognition device 100. FIG. 5 is a diagram schematically illustrating each process performed by the recognition device 100. In FIG. 5, step numbers corresponding to the flowchart illustrated in FIG. 4 are represented. In the flow of the process of the recognition device 100 described below, the flowchart illustrated in FIG. 4 will be described, and the process illustrated in FIG. 5 will be appropriately referred to.

The process of the flowchart illustrated in FIG. 4 is repeatedly executed by the camera 10 for every predetermined time interval over which a two-dimensional image of one frame is captured. The recognition device 100 recognizes each of other vehicles shown in a two-dimensional image output by the camera 10 as a target object and sets a target object area of each of the other vehicles that have been recognized. However, in the following description, for ease of description, it is assumed that only one other vehicle is shown in the two-dimensional image captured by the camera 10.

When a two-dimensional image of one frame is captured by the camera 10, the entire area setting unit 110 acquires a two-dimensional image output by the camera 10 (Step S100).

Next, the entire area setting unit 110 recognizes another vehicle shown in the acquired two-dimensional image and sets an entire area including the recognized other vehicle (Step S102). FIG. 5 illustrates a state in which the entire area setting unit 110 sets an entire area RA to another vehicle shown in a two-dimensional image. The entire area setting unit 110 outputs the acquired two-dimensional image and information representing the range of the set entire area RA to the target object area setting unit 150. The entire area setting unit 110 outputs an entire area image acquired by cutting out the range of the set entire area RA from the acquired two-dimensional image to the reference area setting unit 130.

Next, the reference area setting unit 130 recognizes a reference surface of another vehicle included in the entire area image output by the entire area setting unit 110 and sets a reference area representing the recognized reference surface inside the entire area (Step S104). FIG. 5 illustrates a state in which the reference area setting unit 130 sets a reference area RB to another vehicle shown in the two-dimensional image inside the set entire area RA. The reference area setting unit 130 outputs information representing the range of the reference area RB set inside the entire area image to the target object area setting unit 150.

Next, the target object area setting unit 150 sets a replication area of a size (a size that is the same as that of the reference area or a size acquired by reducing the size of the reference area in consideration of perspective) corresponding to the reference area set by the reference area setting unit 130 to a position diagonally opposite inside the entire area inside the entire area set by the entire area setting unit 110 (Step S106). FIG. 5 illustrates a state in which the target object area setting unit 150 sets a replication area RC having the same size as that of the reference area RB at a position diagonally opposite of the inside the entire area RA.

Thereafter, the target object area setting unit 150 joins points of corresponding corners of the reference area and the replication area using diagonal lines (Step S108). FIG. 5 illustrates a state in which the target object area setting unit 150 joins points of corners of the reference area RB and the replication area RC using diagonal lines SL1 to SL3. More specifically, a state in which a point at a lower right corner of the reference area RB and a point at a lower right corner of the replication area RC are joined using the diagonal line SL1, a point at an upper right corner of the reference area RB and a point at an upper right corner of the replication area RC are joined using the diagonal line SL2, and a point at an upper left corner of the reference area RB and a point at an upper left corner of the replication area RC are joined using the diagonal line SL3 is illustrated.

As illustrated in FIG. 5, a point at a lower left corner of the reference area RB and a point at a lower left corner of the replication area RC are not joined using a diagonal line. The reason for this is that, when a target object area is set thereafter, a diagonal line joining the point at the lower left corner of the reference area RB and the point at the lower left corner of the replication area RC is a line hidden by another vehicle and has no effect on the process performed thereafter. In addition, the processing load of joining the point at the lower left corner of the reference area RB and the point of the lower left corner of the replication area RC using a diagonal line can be reduced in the recognition device 100 (more specifically, the target object area setting unit 150).

Thereafter, the target object area setting unit 150 sets a target object area of another vehicle on the basis of the reference area, the replication area, and the diagonal lines joining the reference area and the replication area (Step S110). FIG. 5 illustrates a state in which the target object area setting unit 150 sets a target object area RO of another vehicle.

Thereafter, the target object area setting unit 150 outputs an image acquired by superimposing the set target object area onto the acquired two-dimensional image to the display device 20 (Step S112). In this way, the display device 20 displays the image output by the target object area setting unit 150. Then, the recognition device 100 ends the process of this flowchart for the current two-dimensional image captured by the camera 10.

In accordance with this configuration and this process, the recognition device 100 sets a target object area that is represented such that another vehicle present in the vicinity of the subject vehicle M is recognized inside a three-dimensional space on the basis of the current two-dimensional image captured by the camera 10. Then, by causing the display device 20 to display the image acquired by superimposing the recognized target object area onto the current two-dimensional image captured by the camera 10, the recognition device 100 visually notifies a driver of the presence of another vehicle such that it is recognized by the subject vehicle M inside a three-dimensional space. In this way, in the subject vehicle M in which the recognition system 1 is mounted, a driver can visually notice that the subject vehicle M has recognized the presence of another vehicle by viewing the image displayed by the display device 20.

### [Example of Display of Target Object Area]

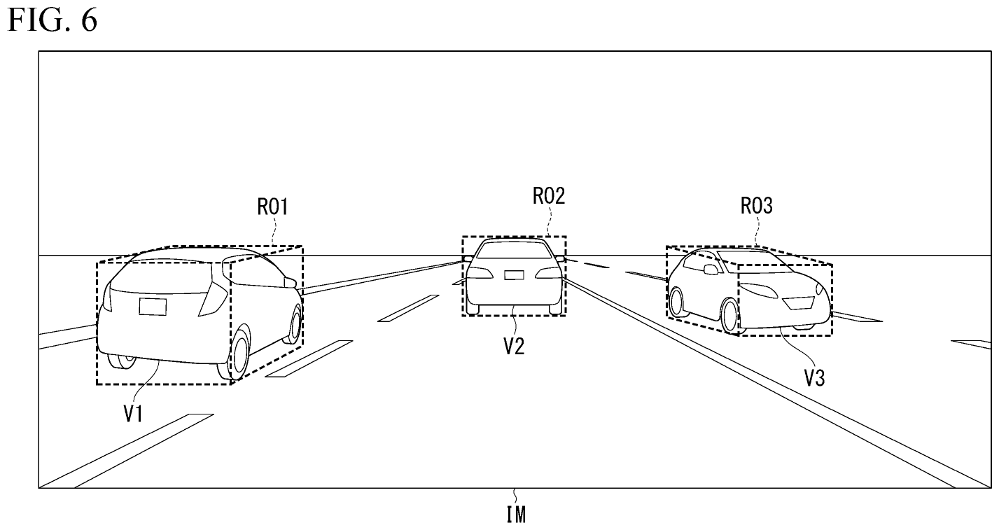

FIG. 6 is a diagram illustrating an example of an image displaying a target object area of another vehicle set by the recognition device 100 in an overlapping manner. FIG. 6 illustrates an example of an image IM in which target object areas RO set by the recognition device 100 recognizing three other vehicles present on a side in front of the subject vehicle M are superimposed. More specifically, FIG. 6 illustrates an example of an image IM in which a target object area RO1 set for another vehicle (hereinafter, referred to as another vehicle V1) traveling in a traveling lane on a left side that is adjacent to a traveling lane in which the subject vehicle M is traveling, a target object area RO2 set for another vehicle (hereinafter, referred to as another vehicle V2) traveling on a side in front in the same traveling lane, and a target object area RO3 set for another vehicle (hereinafter, referred to as another vehicle V3) traveling in an adjacent traveling lane on an opposite side (right side), which are set by the recognition device 100, are superimposed.

As described above, the recognition device 100 performs the process of the flowchart illustrated in FIG. 4 for each of other vehicles (the other vehicles V1 to V3) shown in the two-dimensional image output by the camera 10, thereby setting a target object area of each of the other vehicles that have been recognized.

As illustrated in FIG. 6, a target object area RO2 set by the recognition device 100 (more specifically, the target object area setting unit 150) for the other vehicle V2 is not a target object area that encloses an area of the other vehicle V2 in a stereoscopic shape. The reason for this is that the other vehicle V2 is the other vehicle traveling on a side in front of the same traveling lane as that of the subject vehicle M, and thus the reference area setting unit 130 recognizes that all the area of the entire area set by the entire area setting unit 110 is a reference surface and sets a reference area. Also in this case, the reference area setting unit 130 outputs information relating to the reference area including information representing that the set reference area is the rear face of the other vehicle V2 to the target object area setting unit 150, and thus, for example, the estimation unit 151 included in the target object area setting unit 150 can estimate states of the other vehicle V2 such as a distance between the subject vehicle M and the other vehicle and a moving direction of the other vehicle with respect to the traveling direction of the subject vehicle M. In other words, the estimation unit 151 included in the target object area setting unit 150 can estimate states other than the length of the other vehicle V2 in the longitudinal direction (for example, a vehicle length).

### [Example of Estimation of States of Other Vehicle]

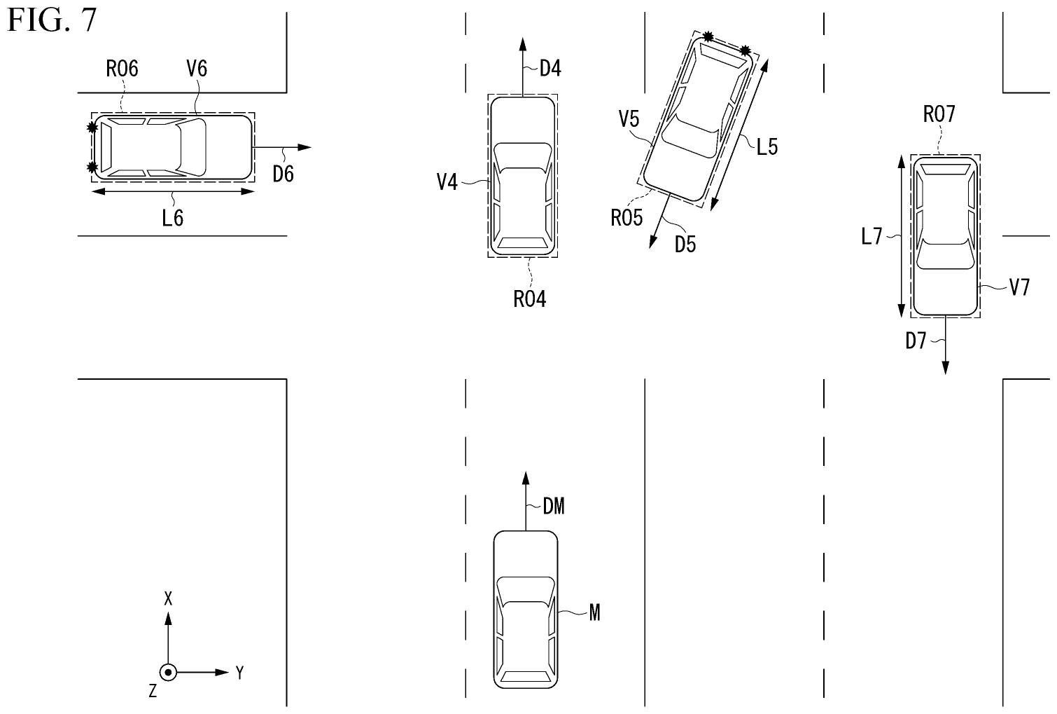

FIG. 7 is a diagram schematically illustrating an example of estimated states of other vehicles on the basis of target object areas of the other vehicles set by the recognition device 100. FIG. 7 illustrates an example of estimated states of other vehicles estimated on the basis of respective target object areas RO that are set by the recognition device 100 recognizing four other vehicles present in front of the subject vehicle M. In FIG. 7, for ease of description, the states of the subject vehicle M and the other vehicles and the target object areas RO set for the other vehicles are illustrated on a two-dimensional plane. In FIG. 7, illustrations of distances between the subject vehicle M and the other vehicles estimated by the recognition device 100 (more specifically, the estimation unit 151) are omitted.

FIG. 7 illustrates an example of a state in which the recognition device 100 recognizes another vehicle (hereinafter, referred to as another vehicle V4) traveling in front in the same traveling lane as the traveling lane in which the subject vehicle M is traveling and sets a target object area RO4. The other vehicle V4 is a preceding vehicle traveling before the subject vehicle M, and thus, the target object area RO4 set by the recognition device 100, similar to the other vehicle V2 illustrated in FIG. 6, is not a target object area that encloses the area of the other vehicle V4 in a stereoscopic shape. In this case, the estimation unit 151 estimates a distance between the subject vehicle M and the other vehicle V4, a moving direction of the other vehicle V4 with respect to the traveling direction DM of the subject vehicle M as a reference, and the like. FIG. 7 illustrates an example of the moving direction D4 of the other vehicle V4 that is estimated by the estimation unit 151.

FIG. 7 illustrates an example of a state in which the recognition device 100 recognizes another vehicle (hereinafter, referred to as other vehicle V5) having a likelihood of entering from an adjacent traveling lane on an opposite side (a right side) when making a right turn at an intersection with another traveling lane intersecting with a traveling lane in which the subject vehicle M is traveling and sets a target object area RO5. In this case, the estimation unit 151 estimates a distance between the subject vehicle M and the other vehicle V5, a moving direction of the other vehicle V5 with respect to the traveling direction DM of the subject vehicle M as a reference, a length of the other vehicle V5 in the longitudinal direction (a vehicle length), and the like. FIG. 7 illustrates an example of the moving direction D5 and the vehicle length LS of the other vehicle V5 that are estimated by the estimation unit 151.

FIG. 7 illustrates an example of a state in which the recognition device 100 recognizes another vehicle (hereinafter, referred to as another vehicle V6) having a likelihood of entering an intersection from another traveling lane (a left side) intersecting with a traveling lane in which the subject vehicle M is traveling and sets a target object area RO6. In this case, the estimation unit 151 estimates a distance between the subject vehicle M and the other vehicle V6, a moving direction of the other vehicle V6 with respect to the traveling direction DM of the subject vehicle M as a reference, a vehicle length of the other vehicle V6, and the like. FIG. 7 illustrates an example of the moving direction D6 and the vehicle length L6 of the other vehicle V6 that are estimated by the estimation unit 151.

FIG. 7 illustrates an example of a state in which the recognition device 100 recognizes another vehicle (hereinafter, referred to as other vehicle V7) traveling in a traveling lane on an opposite side (a right side) away from the traveling lane in which the subject vehicle M is traveling and sets a target object area RO7. In this case, the estimation unit 151 estimates a distance between the subject vehicle M and the other vehicle V7, a moving direction of the other vehicle V7 with respect to the traveling direction DM of the subject vehicle M as a reference, a vehicle length of the other vehicle V7, and the like. FIG. 7 illustrates an example of the moving direction D7 and the vehicle length L7 of the other vehicle V7 that are estimated by the estimation unit 151.

As described above, according to the recognition device 100 of the first embodiment, after recognizing another vehicle shown in a two-dimensional image captured by the camera 10 and setting an entire area, a reference area is set by recognizing a reference surface of the other vehicle inside the entire area, and a target object area is set on the basis of the entire area and the reference area. In this way, the recognition device 100 according to the first embodiment can set target object areas that are represented such that other vehicles present in the vicinity of the subject vehicle M are recognized inside a three-dimensional space on the basis of a two-dimensional image captured by the camera 10. In other words, the recognition device 100 according to the first embodiment can set target object areas that are represented such that other vehicles are recognized inside a three-dimensional space without capturing a three-dimensional image using the camera 10.

In addition, in the recognition device 100 according to the first embodiment, a learned model used for setting an entire area and each reference area is a model for setting each area from a two-dimensional image. In other words, an entire area learned model used for setting an entire area and a reference area learned model used for setting a reference area are models having low (light) processing loads. For this reason, the recognition device 100 according to the first embodiment can recognize other vehicles present inside a three-dimensional space with a low load. As one or both of learned models used for setting an entire area and a reference area, an existing learned model may be used. Also in such a case, the processing load of the learned model becomes low (light), and the recognition device 100 according to the first embodiment can recognize other vehicles present inside a three-dimensional space with a low load.

In accordance with these, the recognition device 100 according to the first embodiment can visually notify a driver of the presence of other vehicles such that the subject vehicle M recognizes the presence of the other vehicles inside a three-dimensional space with a low-load process by causing the display device 20 to display an image acquired by superimposing recognized target object areas onto a two-dimensional image captured by the camera 10 on the display device 20. In addition, the recognition device 100 according to the first embodiment can estimate states of other vehicles on the basis of set target object areas and can cause the display device 20 to display an image acquired by superimposing information representing the estimated states of the other vehicles onto a two-dimensional image. In this way, in the subject vehicle M in which the recognition system 1 including the recognition device 100 according to the first embodiment is mounted, a driver can visually recognize that the subject vehicle M has recognized the presence of other vehicles (for example, recognizing them as a risk) by viewing an image displayed by the display device 20.

### Second Embodiment

Hereinafter, a second embodiment will be described. The second embodiment is an example of a case in which the function of the recognition device 100 according to the first embodiment is mounted in a vehicle system that performs automated driving.

### [Entire Configuration of Vehicle System]

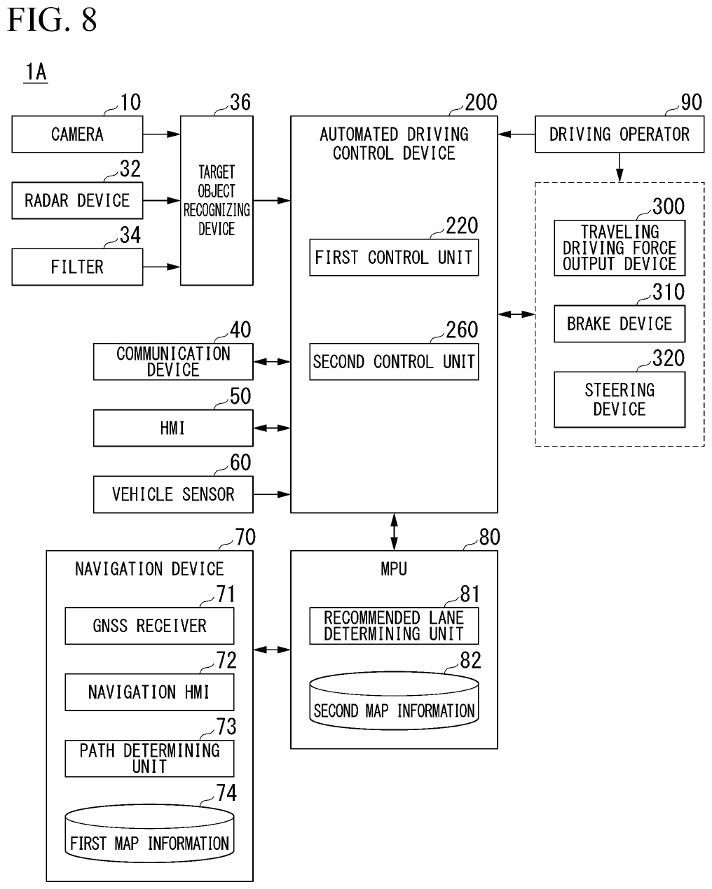

FIG. 8 is a configuration diagram of a vehicle system 1A in which a function of a recognition device according to the second embodiment is mounted. A vehicle in which the vehicle system 1A is mounted, similar to a vehicle in which the recognition system 1 including the recognition device 100 according to the first embodiment is mounted, for example, is also a vehicle having two wheels, three wheels, four wheels, or the like.

The vehicle system 1A, for example, includes: a camera 10; a radar device 32; a finder 34; a target object recognizing device 36; a communication device 40; a human machine interface (HMI) 50; a vehicle sensor 60; a navigation device 70; a map positioning unit (MPU) 80; a driving operator 90; an automated driving control device 200; a traveling driving force output device 300; a brake device 310; and a steering device 320. The configuration illustrated in FIG. 8 is merely an example. Thus, a part of the configuration may be omitted, and different constituents may be further added thereto.

The constituent elements included in the vehicle system 1A include constituent elements that are similar to those of the recognition device 100 according to the first embodiment and the recognition system 1 including the recognition device 100 are included. In the following description, the same reference signs will be assigned to constituent elements that are similar to those of the recognition device 100 according to the first embodiment and the recognition system 1 including the recognition device 100 among the constituent elements included in the vehicle system 1A, and detailed description of these constituent elements will be omitted.

The radar device 32 emits radio waves such as millimeter waves to the vicinity of the subject vehicle M and detects at least a position of (a distance and an azimuth) a target object by detecting radio waves (reflected waves) reflected by the target object. The radar device 32 is installed at an arbitrary place on the subject vehicle M.

The finder 34 is a light detection and ranging (LIDAR) device. The finder 34 emits light to the vicinity of the subject vehicle M and measures scattered light. The finder 34 detects a distance with respect to a target on the basis of a time from light emission to light reception. The emitted light, for example, is pulse-form laser light. The finder 34 is mounted at an arbitrary position on the subject vehicle M.

The target object recognizing device 36 performs a sensor fusion process on results of detection using some or all of the camera 10, the radar device 32, and the finder 34, thereby recognizing a position, a type, a speed, and the like of a target object. The target object recognizing device 36 outputs a result of recognition to the automated driving control device 200. The target object recognizing device 36 may output results of detection acquired by the camera 10, the radar device 32, and the finder 34 to the automated driving control device 200 as they are. The target object recognizing device 36 may be omitted from the vehicle system 1A.

The communication device 40, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 50 presents various types of information to an occupant of the subject vehicle M and receives an input operation performed by a vehicle occupant. The HMI 50 includes various display devices, a speaker, a buzzer, a touch panel, switches, keys, and the like. The display device included in the HMI 50 may be configured to be the same as the display device 20 of the recognition system 1 including the recognition device 100 according to the first embodiment.

The vehicle sensor 60 includes a vehicle speed sensor that detects a speed of the subject vehicle M, an acceleration sensor that detects an acceleration, a yaw rate sensor that detects an angular velocity around a vertical axis, an azimuth sensor that detects the azimuth of the subject vehicle M, and the like.

The navigation device 70, for example, includes a global navigation satellite system (GNSS) receiver 71, a navigation HMI 72, and a path determining unit 73. The navigation device 70 stores first map information 74 in a storage device such as an HDD or a flash memory. The GNSS receiver 71 identifies a position of the subject vehicle M on the basis of signals received from GNSS satellites. The navigation HMI 72 includes a display device, a speaker, a touch panel, a key, and the like. The display device included in the navigation HMI 72 may be configured to be the same as the display device 20 of the recognition system 1 including the recognition device 100 according to the first embodiment. The navigation HMI 72 may be configured to be partially or entirely the same as the HMI 50 described above. The path determining unit 73, for example, determines a path from a position of the subject vehicle M identified by the GNSS receiver 71 (or an input arbitrary position) to a destination input by a vehicle occupant using the navigation HMI 72 (hereinafter referred to as a path on a map) by referring to the first map information 74. The first map information 74, for example, is information in which a road form is represented using respective links representing roads and respective nodes connected using the links. The path on the map is output to the MPU 80.

The MPU 80, for example, includes a recommended lane determining unit 81 and stores second map information 82 in a storage device such as an HDD or a flash memory. The recommended lane determining unit 81 divides the path on the map provided from the navigation device 70 into a plurality of blocks (for example, divides the path into blocks of 100 [m] in the traveling direction of the vehicle) and determines a recommended lane for each block by referring to the second map information 82. The recommended lane determining unit 81 determines in which of lanes numbered from the left side to travel.

The second map information 82 is map information having higher accuracy than the first map information 74. The second map information 82, for example, includes information on the centers of respective lanes, information on boundaries between lanes, or the like. In the second map information 82, road information, traffic regulation information, address information (addresses and postal codes), facility information, telephone number information, and the like may be included.

The driving operator 90, for example, includes an acceleration pedal, a brake pedal, a shift lever, a steering wheel, a steering wheel variant, a joystick, and other operators. A sensor detecting the amount of an operation or the presence/absence of an operation is installed in the driving operator 90, and a result of the detection is output to the automated driving control device 200 or some or all of the traveling driving force output device 300, the brake device 310, and the steering device 320.

The automated driving control device 200, for example, includes a first control unit 220 and a second control unit 260. For example, each of the first control unit 220 and the second control unit 260 is realized by a hardware processor such as a CPU executing a program (software). Some or all of these constituent elements may be realized by hardware (a circuit unit; including circuitry) such as a LSI, an ASIC, an FPGA, or a GPU or may be realized by software and hardware in cooperation. Some or all of such constituent elements may be realized by a dedicated LSI.

The program (software) may be stored in a storage device (a storage device including a non-transitory storage medium) such as an HDD or a flash memory of the automated driving control device 200 in advance or may be stored in a storage medium (non-transitory storage medium) such as a DVD or a CD-ROM that can be loaded or unloaded and installed in an HDD or a flash memory of the automated driving control device 200 by loading the storage medium into a drive device. In the vehicle system 1A, the function of the recognition device 100 according to the first embodiment is executed as the function of the automated driving control device 200.

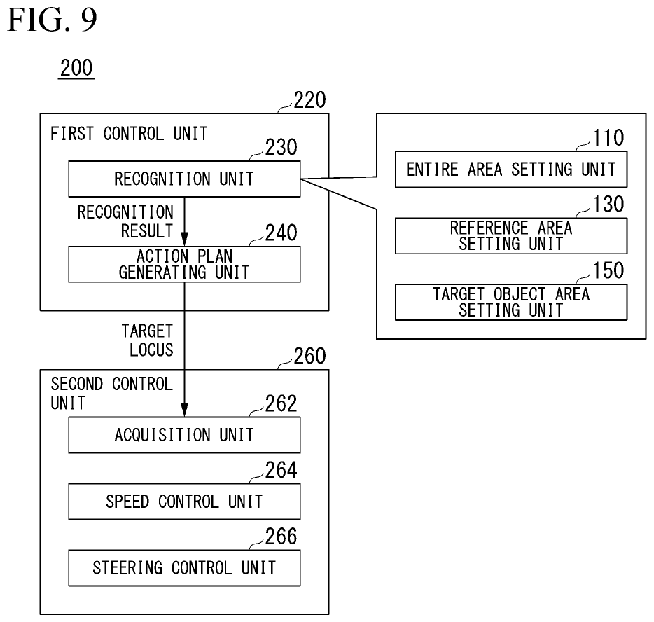

FIG. 9 is a functional configuration diagram of the first control unit 220 and the second control unit 260. The first control unit 220, for example, includes a recognition unit 230 and an action plan generating unit 240. The first control unit 220, for example, simultaneously realizes functions using artificial intelligence (AI) and functions using a model provided in advance.

The recognition unit 230 recognizes states such as positions, speeds, and accelerations of target objects present in the vicinity of the subject vehicle M on the basis of information input from the camera 10, the radar device 32, and the finder 34 through the target object recognizing device 36. The recognition unit 230, for example, recognizes a lane in which the subject vehicle M is traveling (a traveling lane). When a traveling lane is recognized, the recognition unit 230 recognizes a position and a posture of the subject vehicle M with respect to the traveling lane.

In the vehicle system 1A, the function of the recognition device 100 according to the first embodiment is executed as the function of the recognition unit 230. For this reason, the recognition unit 230 includes the entire area setting unit 110, the reference area setting unit 130, and the target object area setting unit 150 included in the recognition device 100 according to the first embodiment. In the recognition unit 230, some functions of the recognition unit 230 described above are realized by the entire area setting unit 110, the reference area setting unit 130, and the target object area setting unit 150. More specifically, other vehicles among target objects present in the vicinity of the subject vehicle M are recognized by the entire area setting unit 110, the reference area setting unit 130, and the target object area setting unit 150. The recognition unit 230 outputs information representing states of other vehicles including positions of the other vehicles estimated by the estimation unit 151 included in the target object area setting unit 150 to the action plan generating unit 240 as a result of the recognition.

The action plan generating unit 240 generates a target locus along which the subject vehicle M will automatedly travel in the future such that the subject vehicle basically travels in a recommended lane determined by the recommended lane determining unit 81 and can respond to a surrounding status of the subject vehicle M. The target locus, for example, includes a speed element. For example, the target locus is represented by sequentially aligning places at which the subject vehicle M will arrive. When a target locus is generated, the action plan generating unit 240 may set an event of automated driving.

The second control unit 260 performs control of the traveling driving force output device 300, the brake device 310, and the steering device 320 such that the subject vehicle M passes along a target locus generated by the action plan generating unit 240 at a scheduled time.

Referring back to FIG. 9, the second control unit 260, for example, includes an acquisition unit 262, a speed control unit 264, and a steering control unit 266. The acquisition unit 262 acquires information of a target locus (locus points) generated by the action plan generating unit 240 and stores the acquired information in a memory (not illustrated in the drawing). The speed control unit 264 controls the traveling driving force output device 300 or the brake device 310 on the basis of a speed element accompanying a target locus stored in the memory. The steering control unit 266 controls the steering device 320 in accordance with a curved state of the target locus stored in the memory.

The traveling driving force output device 300 outputs a traveling driving force (torque) used for a vehicle to travel to driving wheels. The traveling driving force output device 300, for example, includes a combination of an internal combustion engine, an electric motor, a transmission, and the like and an electronic control unit (ECU) controlling these components. The ECU controls the components described above in accordance with information input from the second control unit 260 or information input from the driving operator 90.

The brake device 310, for example, includes a brake caliper, a cylinder that delivers hydraulic pressure to the brake caliper, an electric motor that generates hydraulic pressure in the cylinder, and a brake ECU.

The brake ECU performs control of the electric motor in accordance with information input from the second control unit 260 or information input from the driving operator 90 such that a brake torque according to a brake operation is output to each vehicle wheel. The brake device 310 is not limited to the configuration described above and may be an electronically-controlled hydraulic brake device that delivers hydraulic pressure in the master cylinder to a cylinder by controlling an actuator in accordance with information input from the second control unit 260.

The steering device 320, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second control unit 260 or information input from the driving operator 90.

As described above, according to the vehicle system 1A of the second embodiment in which the function of the recognition device is mounted, target object areas are set by recognizing other vehicles shown in a two-dimensional image captured by the camera 10. In this way, in the vehicle system 1A according to the second embodiment, other vehicles present inside a three-dimensional space can be recognized with a low load on the basis of a two-dimensional image captured by the camera 10 and automated driving of the subject vehicle M controlled without capturing a three-dimensional image using the camera 10. In the subject vehicle M in which the vehicle system 1A according to the second embodiment is mounted, by installing the camera 10 capturing a two-dimensional image, an automated driving system can be realized with a cost lower than in a case in which a camera capturing a three-dimensional image is installed.

As described above, in the recognition device according to an embodiment, a target object area representing an area of another vehicle shown in a two-dimensional image to be recognized inside a three-dimensional space is set using the entire area learned model for setting an entire area of the other vehicle and the reference area learned model for setting a reference area of the other vehicle inside the entire area. In this way, in the recognition device according to the embodiment, other vehicles inside a three-dimensional space can be recognized using a process having a further lower load. For example, in a conventional process in which other vehicles are recognized inside a three-dimensional space, it is required to recognize the other vehicles using measurement of vehicle lengths of the other vehicles or a more complex learned model. On the other hand, in the recognition device according to the embodiment, by recognizing and setting two areas including an entire area and a reference area in a two-dimensional image as described above, other vehicles can be recognized inside a three-dimensional space.

In addition, since the learned model used by the recognition device according to an embodiment is a learned model for setting an entire area or a reference area, data (learning data (image data) or correct answer data (teacher data)) used when this learned model is generated does not need to be complex (special) data unlike data used when a learned model for three-dimensionally recognizing other vehicles is generated. In other words, machine learning for a learned model used by the recognition device according to an embodiment can be performed more easily than machine learning for a learned model for three-dimensionally recognizing other vehicles, and a learning cost for the machine learning can be reduced to a low level.

In this way, in the recognition system 1 including the recognition device according to an embodiment or the subject vehicle M in which the vehicle system 1A is mounted, other vehicles present inside a three-dimensional space can be realized with a lower load and a lower cost.

For example, according to the recognition device 100 of the first embodiment described above, by including the entire area setting unit 110 that recognizes another vehicle shown in a two-dimensional image captured by the camera 10 imaging the vicinity of the subject vehicle M and sets an entire area including the recognized other vehicle inside the two-dimensional image, the reference area setting unit 130 that sets a reference area coinciding with a reference surface among surfaces constituting the other vehicle, and the target object area setting unit 150 that sets a target object area representing an area of the other vehicle in a predetermined shape (a stereoscopic shape representing the other vehicle to be recognized inside a three-dimensional space) on the basis of the entire area and the reference area, the presence of other vehicles present in the vicinity of the subject vehicle M can be visually notified to a driver such that the presence is recognized inside a three-dimensional space.

### [Hardware Configuration]

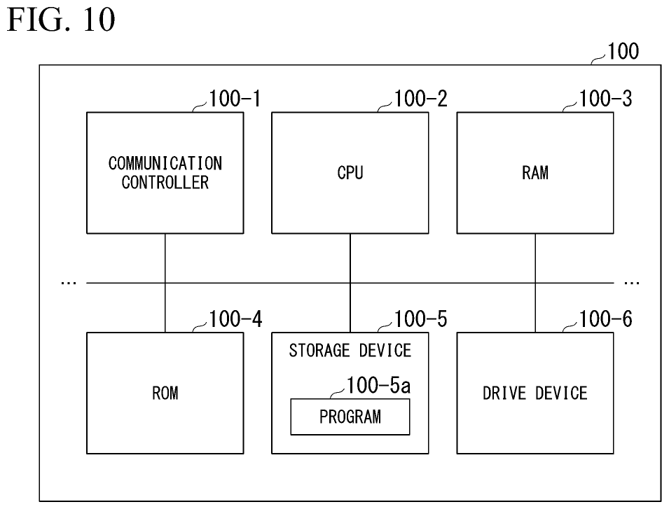

FIG. 10 is a diagram illustrating one example of the hardware configuration of the recognition device 100 according to the first embodiment. As illustrated in the drawing, the recognition device 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or an HDD, a drive device 100-6, and the like are interconnected through an internal bus or a dedicated communication line. The communication controller 100-1 communicates with constituent elements other than the recognition device 100. A program 100-5a executed by the CPU 100-2 is stored in the storage device 100-5. This program is expanded into the RAM 100-3 by a direct memory access (DMA) controller (not illustrated in the drawing) or the like and is executed by the CPU 100-2. In this way, the recognition device 100, more specifically, some or all of the entire area setting unit 110, the reference area setting unit 130, and the target object area setting unit 150 are realized.

The hardware configuration of the automated driving control device 200 according to the second embodiment is similar to the hardware configuration of the recognition device 100 according to the first embodiment illustrated in FIG. 10. Thus, detailed description of the hardware configuration of the automated driving control device 200 according to the second embodiment will be omitted.

The embodiment described above can be represented as below.

A recognition device including a hardware processor and a storage device storing a program and configured such that, by the hardware processor reading and executing a program stored in the storage device, it recognizes a target object shown in a two-dimensional image captured by an imaging device capturing the vicinity of a vehicle, sets a first area including the recognized target object inside the two-dimensional image, sets a second area coinciding with a reference surface among surfaces constituting the target object, and sets a third area representing the area of the target object in a predetermined shape on the basis of the first area and the second area.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A recognition device comprising:
a first area setting unit configured to recognize a target object shown in a two-dimensional image captured by an imaging device imaging a vicinity of a vehicle and set a first area including the recognized target object inside the two-dimensional image;
a second area setting unit configured to set a second area coinciding with a reference surface among surfaces constituting the target object; and
a third area setting unit configured to set a third area representing an area of the target object in a predetermined shape on the basis of the first area and the second area.

2. The recognition device according to claim 1,
wherein the target object is another vehicle present in the vicinity of the vehicle, and
wherein the reference surface is a front face or a rear face of the other vehicle.

3. The recognition device according to claim 1,
wherein the first area setting unit acquires and sets the first area by inputting the two-dimensional image to a first learned model that has learned to output the first area when the two-dimensional image is input, and
wherein the second area setting unit acquires and sets the second area by inputting an image of the first area to a second learned model that has learned to output the second area when the image of the first area is input.

4. The recognition device according to claim 1, wherein the third area setting unit sets a fourth area, which has the same size as that of the second area or a size reduced with perspective taken into account, at a position diagonally opposite to the second area inside the first area and sets the third area representing a stereoscopic shape by joining points of corresponding corners of the second area and the fourth area using straight lines.

5. The recognition device according to claim 4, further comprising a first estimation unit configured to estimate a moving direction of another vehicle on the basis of the straight lines joining the points of the corresponding corners of the second area and the fourth area in the third area,
wherein the target object is the other vehicle present in the vicinity of the vehicle.

6. The recognition device according to claim 4, further comprising a second estimation unit configured to estimate a length of another vehicle in a longitudinal direction on the basis of the straight lines joining the points of the corresponding corners of the second area and the fourth area in the third area,
wherein the target object is the other vehicle present in the vicinity of the vehicle.

7. A recognition method using a computer, the recognition method comprising:
recognizing a target object shown in a two-dimensional image captured by an imaging device imaging a vicinity of a vehicle and setting a first area including the recognized target object inside the two-dimensional image;
setting a second area coinciding with a reference surface among surfaces constituting the target object; and
setting a third area representing an area of the target object in a predetermined shape on the basis of the first area and the second area.

8. A computer-readable non-transitory storage medium storing a program causing a computer to execute:
recognizing a target object shown in a two-dimensional image captured by an imaging device imaging a vicinity of a vehicle and setting a first area including the recognized target object inside the two-dimensional image;
setting a second area coinciding with a reference surface among surfaces constituting the target object; and
setting a third area representing an area of the target object in a predetermined shape on the basis of the first area and the second area.
